(19) United States
(12) Patent Application Publication
(10) Pub. No.: US 2008/0218751 A1
(43) Pub. Date: Sep. 11, 2008

(54) Inspection device and inspection method of an object to be inspected

(75) Inventors: Takahiro Togashi, Mito (JP); Shigeru Matsui, Hitachinaka (JP)

Correspondence Address: MCDERMOTT WILL & EMERY LLP, 600 13TH STREET, N.W., WASHINGTON, DC, 20005-3096, US

(73) Assignee: HITACHI HIGH-TECHNOLOGIES CORPORATION

(21) Appl. No.: 12/073,295

(22) Filed: Mar. 4, 2008

(30) Foreign Application Priority Data
Mar. 5, 2007 (JP) 2007-054217

(51) Int. Cl. G01N 21/00

(52) U.S. Cl. 356/237.5

(57) ABSTRACT

An inspection device of an object, comprising: a laser beam source for oscillating a laser beam and irradiating the laser beam onto a surface of an object to be inspected, a rotary table for loading and rotating the object, a moving mechanism for moving the rotary table in a transfer direction of the object, a plurality of light receptors disposed above the object for receiving a scattering light scattered from the surface of the object when the laser beam irradiated from the laser beam source onto the surface of the object loaded on the rotary table, and a data processor for performing operations on the basis of received signals of the scattering light received by the plurality of light receptors and discriminating a boundary position between a flat plane area of the surface of the object which is irradiated with the laser beam and a predetermined area corresponding to an edge portion outside the plane area.

### CLAIM OF PRIORITY

The present application claims priority from Japanese application serial No. 2007-054217, filed on Mar. 5, 2007, the content of which is hereby incorporated by reference into this application.

### BACKGROUND OF THE INVENTION

1. Field of the Invention

The present invention relates to an inspection device and an inspection method of an object to be inspected such as a wafer and more particularly to an inspection device and an inspection method of an object to be inspected by irradiating a laser beam onto the surface of the object such as a wafer, thereby inspecting the condition of particles or defects existing on the surface of the object.

2. Description of Related Art

As an example of the inspection device of an object to be inspected such as a wafer, in Japanese Patent Application Laid-open Publication No. Hei 9 (1997)-304289, an art of an inspection device of the surface of a wafer which is an object to be inspected is disclosed.

In this art of the inspection device of the surface of a wafer disclosed in the Japanese Patent Application Laid-open Publication No. Hei 9 (1997)-304289, the laser beam outputted from the laser beam source is changed to a laser spot Sp (hereinafter, referred to as a spot Sp) by the lens system, is projected perpendicularly or obliquely onto the wafer surface which is an object to be inspected, scans spirally the wafer surface according to the movement of the wafer, thereby scans overall the wafer surface.

And, when there are particles e or defects such as scratches or crystalline defects (COP) on the wafer surface, the spot Sp outputted from the laser beam source generates scattering light Se at a wide angle (direction) by the particles e or defects such as COP, and a part of the scattering light Se is collected by the collecting lens and is received by the photo multiplier tube (hereinafter, referred to as PMT) of the light receptor which is a photoelectric converter.

The scattering light Se entering the PMT is converted here to an electric signal, and the converted electric signal (received signal) is data-processed, thus foreign particle data indicating the number and size of the particles e and defects such as COP and the positions of the particles and defects is generated, and the condition of the particles e and defects is mapped on a printer or a display (not drawn).

In the inspection device of the surface of a wafer disclosed in the Japanese Patent Application Laid-open Publication No. 2006-201179, as an art for detecting defects in the neighborhood of the edge of the wafer, the art for using the property that when irradiating a laser beam onto the wafer surface, scattering light generated from the edge of the wafer is distributed in the normal direction at the edge with strong directivity, though scattering light generated from the defective portion has no conspicuous directivity and depending on the strength of the directivity of the scattering light detected by the detector positioned in the tangential direction at the edge of the wafer, for deciding whether the scattering light is scattering light only from the edge portion of the wafer or scattering light including the defective portion is disclosed.

Patent Document 1: Japanese Patent Application Laid-open Publication No. Hei 9 (1997)-304289

Patent Document 2: Japanese Patent Application Laid-open Publication No. 2006-201179

### SUMMARY OF THE INVENTION

However, in the inspection art described in Japanese Patent Laid-open No. 2006-201179, when inspecting continuously overall the surface of a wafer which is an object to be inspected by irradiating a laser beam, it is influenced by strong diffracted light generated from the edge portion of the wafer by irradiation of the laser beam, so that the light receiver for detecting scattering light generated from particles and scratches on the wafer surface is deteriorated comparatively for a short period, thus scattering light generated from particles and defects such as COP existing in the edge portion of the wafer cannot be detected precisely, so that a problem arises that it is difficult to detect the particles and defects such as COP in the edge portion of the wafer.

Similarly, in the inspection art described in the Japanese Patent Application Laid-open Publication No. Hei 9 (1997)-304289, when inspecting continuously overall the surface of a wafer which is the object to be inspected by irradiating a laser beam, a received signal received by the light receiver for detecting scattering light generated from particles and scratches on the wafer surface is influenced by strong diffracted light generated in the edge portion of the wafer, thus the noise component is increased, and scattering light generated from particles and defects such as COP existing on the wafer surface is buried in the noise component, so that a problem arises that it is difficult to detect precisely existence of particles and defects such as COP in the edge portion of the wafer.

On the other hand, in the inspection arts using a laser beam as described in the Japanese Patent Application Laid-open Publication No. 2006-201179 and the Japanese Patent Application Laid-open Publication No. Hei 9 (1997)-304289, a predetermined area corresponding to the area of the edge portion of the wafer in the neighborhood of the plane area corresponding to the area inspected for particles and scratches on the surface of the wafer which is the object to be inspected by irradiating a laser beam, as mentioned above, since the strong diffracted light generated in the predetermined area enters the light receptor (PMT) for detecting scattering light, causing a breakdown of the light receptor, is handled as a non-inspection area free of irradiation of a laser beam for scanning particles and scratches.

The predetermined area which is a non-inspection area of the object to be inspected, due to the eccentricity of the wafer itself as the object which is a subject to be measured by irradiating a laser beam and a difference in the outside diameter due to the individual difference of the wafer, is varied in the size of the predetermined area of the wafer surface.

Therefore, when inspecting the surface of the object by irradiating a laser beam, it is necessary to set the range of the plane area which is an inspection subject of the surface of a wafer which is the object as wide as possible and inspect the plane area by scanning with a laser beam, though it is desirable, in order to set and inspect the aforementioned plane area of the wafer surface as wide as possible, to discriminate precisely the range of the predetermined area corresponding to the edge portion of the wafer, that is, discriminate precisely the boundary position between the plane area and the predetermined area neighboring with the plane area and set and inspect the range of the predetermined area as small as possible.

An object of the present invention is to provide an inspection device and an inspection method of an object to be inspected, when inspecting the surface of the object by irradiating a laser beam, to enable to set the range of the plane area which is an inspection subject of the object as wide as possible, for discriminating precisely and inspecting the boundary position between the plane area and the predetermined area corresponding to the edge portion of the object neighboring with the plane area.

The inspection device of an object to be inspected of the present invention comprising: a laser beam source for oscillating a laser beam and irradiating the laser beam onto a surface of an object to be inspected, a rotary table for loading and rotating the object, a moving mechanism for moving the rotary table in a transfer direction of the object, a plurality of light receptors disposed above the object for receiving a scattering light scattered from the surface of the object when the laser beam irradiated from the laser beam source onto the surface of the object loaded on the rotary table, and a data processor for performing operations on the basis of received signals of the scattering light received by the plurality of light receptors and discriminating a boundary position between a flat plane area of the surface of the object which is irradiated with the laser beam and a predetermined area corresponding to an edge portion outside the plane area.

Further, the inspection device of an object to be inspected of the present invention comprising: a laser beam source for oscillating a laser beam and irradiating the laser beam onto a surface of an object to be inspected, a rotary table for loading and rotating the object, a moving mechanism for moving the rotary table in a transfer direction of the object, a plurality of light receptors disposed above the object for receiving a scattering light scattered from the surface of the object when the laser beam irradiated from the laser beam source onto the surface of the object loaded on the rotary table, a half-mirror disposed half way an optical path of the laser beam irradiated onto the surface of the object in a vertical direction from above for transmitting the laser beam, a camera for picking up an image of a laser spot of the laser beam irradiated onto the surface of the object which is reflected in the half-mirror, and a data processor for performing operations on the basis of the image of the laser beam spot picked up by the camera and received signals of the scattering light received by the plurality of light receptors, wherein the data processor performs operations on the basis of the image of the laser spot to discriminate a boundary position between a flat plane area of the surface of the object which is irradiated with the laser beam and a predetermined area corresponding to an edge portion outside the plane area.

Further, the inspection device of an object to be inspected of the present invention comprising: a laser beam source for oscillating a laser beam and irradiating the laser beam onto a surface of an object to be inspected, a rotary table for loading and rotating the object, a moving mechanism for moving the rotary table in a transfer direction of the object, a plurality of light collecting mirrors disposed above the object for collecting a scattering light scattered from the surface of the object when the laser beam irradiated from the laser beam source onto the surface of the object loaded on the rotary table, a line sensor having a plurality of sensors disposed above the object for receiving the scattering light collected by the light collection mirrors, and a data processor for performing operations on the basis of received signals of the scattering light received by the sensors on the line sensor, wherein the data processor performs operations on the basis of the received signals of the scattering light detected by the plurality of sensors of the line sensor to discriminate a boundary position between a flat plane area of the surface of the object which is irradiated with the laser beam and a predetermined area corresponding to an edge portion outside the plane area.

The inspection method of an object to be inspected of the present invention comprising the steps of: driving a rotary table and a moving mechanism to move the rotary table in a transfer direction of an object to be inspected and rotating the object loaded on the rotary table, irradiating a laser beam from a laser beam source disposed above the object onto a surface of the object, receiving a scattering light scattered from the surface of the object by a plurality of light receptors disposed above the object when the laser beam irradiated from the laser beam source onto the surface of the object, and performing operations by a data processor on the basis of received signals of the scattering light received by the plurality of light receptors and discriminating a boundary position between a flat plane area of the surface of the object which is irradiated with the laser beam and a predetermined area corresponding to an edge portion outside the plane area.

Further, the inspection method of an object to be inspected of the present invention comprising the steps of: driving a rotary table and a moving mechanism to move the rotary table in a transfer direction of an object to be inspected and rotating the object loaded on the rotary table, irradiating a laser beam from a laser beam source disposed above the object onto a surface of the object, receiving a scattering light scattered from the surface of the object by a plurality of light receptors disposed above the object when the laser beam irradiated from the laser beam source onto the surface of the object, reflecting an image of a laser spot of the laser beam irradiated from the laser beam source onto the surface of the object by a half-mirror disposed above the object for transmitting the laser beam, picking up an image of the laser spot of the laser beam irradiated onto the surface of the object which is reflected in the half-mirror by a camera, and performing operations by a data processor on the basis of the image of the laser spot picked up by the camera and discriminating a boundary position between a flat plane area of the surface of the object which is irradiated with the laser beam and a predetermined area corresponding to an edge portion outside the plane area.

Further, the inspection method of an object to be inspected of the present invention comprising the steps of: driving a rotary table and a moving mechanism to move the rotary table in a transfer direction of an object to be inspected and rotating the object loaded on the rotary table, irradiating a laser beam from a laser beam source disposed above the object onto a surface of the object, collecting a scattering light scattered from the surface of the object by a plurality of light collecting mirrors disposed above the object when the laser beam irradiated from the laser beam source onto the surface of the object, receiving the scattering light collected by the light collecting mirrors by a line sensor having a plurality of sensors, and performing operations by a data processor on the basis of received signals of the scattering light received respectively by the plurality of sensors of the line sensor and discriminating a boundary position between a flat plane area of the surface of the object which is irradiated with the laser beam and a predetermined area corresponding to an edge portion outside the plane area.

According to the present invention, when inspecting the surface of an object to be inspected by irradiating a laser beam, to enable to set the range of the plane area which is an inspection subject of the object as wide as possible, an inspection device and an inspection method of the object to be inspected for discriminating precisely and inspecting the boundary position between the plane area and the predetermined area corresponding to the edge portion of the object neighboring with the plane area can be realized.

### BRIEF DESCRIPTION OF THE DRAWINGS

FIG. 1 is a conceptual diagram, when a laser beam is irradiated to a semiconductor wafer which is an object to be inspected, showing the strength of diffracted light generated at the edge of the wafer, and FIG. 1(a) is a top view of the condition of the diffracted light generated in the edge area of the wafer viewed from top, and FIG. 1(b) is a partial side view of the diffracted light generated in the edge area of the wafer viewed from side, and Fig. (c) is an illustration showing the condition of scattering light generated from a particle adhered to the surface of the wafer,

FIG. 2 is a schematic view of the light receptors composing the inspection device of an object to be inspected in the embodiment of the present invention shown in FIG. 3, and FIG. 2(a) is a top view showing the arrangement condition of the light receptors, and FIG. 2(b) is a schematic view showing the processing contents of the received signal when scattering light generated on the wafer surface is detected by the light receptor,

FIG. 3 is a schematic block diagram of a detection optical system composing the inspection device of an object to be inspected in an embodiment of the present invention,

FIG. 4 is an illustration showing the inspection condition of the edge area of the wafer by the inspection device of an object in the embodiment of the present invention shown in FIG. 3, and FIG. 4(a) is a schematic view of the edge area of the wafer to which a laser beam is irradiated, and FIG. 4(b) is a drawing showing the strength ratio of the noise components of the received signals of the scattering light detected by the light receptors of this embodiment, and FIG. 4(c) is an illustration showing a setting screen example of a threshold value Th on the screen of the strength ratio of the noise components shown in FIG. 4(b),

FIG. 5 is a flow chart showing the wafer inspection procedures by the inspection device of an object in the embodiment of the present invention shown in FIG. 3,

FIG. 6 is a schematic block diagram of an optical system composing the inspection device of an object to be inspected which is another embodiment of the present invention, and

FIG. 7 is a schematic block diagram showing another optical system composing the inspection device of an object to be inspected which is still another embodiment of the present invention.

### DETAILED DESCRIPTION OF THE PREFERRED EMBODIMENTS

The inspection device and inspection method of an object to be inspected which are the embodiments of the present invention will be explained below with reference to the accompanying drawings.

### Embodiment 1

An object to be inspected to which the inspection device and inspection method of an object to be inspected which is the embodiment of the present invention is, for example, a semiconductor wafer, a wafer-shaped article, or an insulating wafer (for example, a sapphire glass wafer, a quartz glass wafer, etc.).

Therefore, the inspection device and inspection method of an object to be inspected, which is an embodiment of the present invention, applied to the surface inspection of a semiconductor wafer as the object to be inspected will be explained next.

A silicone wafer which is a material of a semiconductor IC is formed from high-purity-polycrystalline silicon. The silicone wafer is produced by preparing a single-crystal silicone ingot by the pickup method, slicing the single-crystal silicone ingot to a plurality of thin plate, grinding the surface and outer peripheral end portion of the thin silicone wafer, and finishing it to a mirror surface.

Furthermore, particles adhered to the surface of the thin silicone wafer are cleaned, thus a silicone wafer is prepared.

During the silicone wafer manufacturing steps, particles may be adhered to or cracks may be generated in the outer peripheral end portion of the wafer.

With respect to particles adhered to the outer peripheral end portion of the wafer or defects such as cracks, scratches, and COP, particularly in a wafer with a large aperture (300 mm), it is highly possible that they become fatal defects and the necessity of inspection of particles and scratches of the wafer surface is required.

As an inspection device of an object to be inspected which is an embodiment of the present invention, the inspection device of the surface of a wafer which is the object to be inspected irradiates a laser beam to the wafer surface from the central part of the wafer to the outer peripheral part, receives scattering light scattered on the wafer surface, and on the basis of the received scattering light, inspects the surface of the wafer of the object.

On the other hand, in the wafer inspection device, in the outer peripheral part of the wafer surface, the area where a noise signal becomes high under the influence of strong diffracted light generated in the edge portion of the wafer due to irradiation of the laser beam is removed from the wafer surface inspection area as a non-inspection area so as to avoid the noise influence.

However, as mentioned above, in the outer peripheral part of the wafer surface, when the area where the noise signal becomes high under the influence of the strong diffracted light is removed from the wafer surface inspection area, scattering light scattered on the wafer surface in the area where the noise becomes high under the influence of the diffracted light cannot be received, so that information on particles adhered to the wafer surface in the concerned area and defects generated on the wafer surface cannot be obtained.

Therefore, the inspection device of an object which is an embodiment of the present invention is structured such that a plurality of light receptors for detecting scattering light scattered on the wafer surface by the laser beam irradiated onto the wafer surface are disposed, and using the characteristic that the strong diffracted force generated in the edge portion of the wafer due to irradiation of the laser beam is emitted always in the same direction (azimuth), from the plurality of light receptors, the light receptors arranged at an angle (direction) free of the influence of the diffracted light generated in the edge portion of the wafer are selected and receive scattering light, thus information on particles adhered to the wafer surface and defects generated on the wafer surface can be obtained overall the wafer surface.

Further, the inspection device of an object which is an embodiment of the present invention is structured such that a plurality of light receptors for detecting scattering light scattered on the wafer surface by the laser beam irradiated onto the wafer surface are disposed and by performing operations on the basis of the received signal of the scattering light received by the plurality of light receptors, the boundary position between the flat plane area of the surface of the object to be inspected which is irradiated with the laser beam and a predetermined area corresponding to the edge portion outside the plane area can be discriminated.

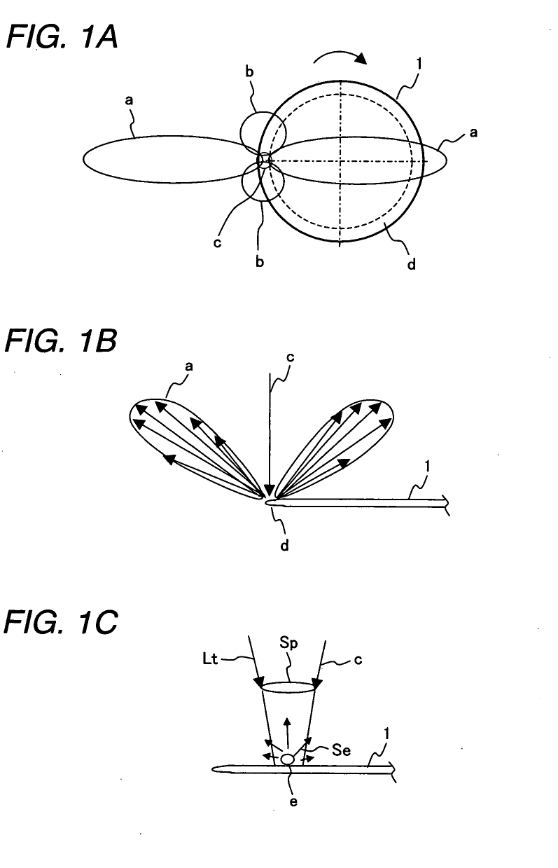

By referring to FIGS. 1 to 5, the inspection device of an object which is an embodiment of the present invention will be explained in detail. Firstly, FIG. 1 is a conceptual diagram showing a semiconductor wafer 1 as an object to be inspected, the condition of a laser beam Lt irradiated to the semiconductor wafer 1, the strength of diffracted light a generated in an edge portion d of the wafer 1 by irradiation of the laser beam Lt, and scattering light Se generated from a particle on the surface of the wafer 1 by irradiation of the laser beam Lt.

And, FIG. 1(a) is a top view showing the strong diffracted light a and weak diffracted light b generated in the edge portion d of the wafer 1 which are viewed from above, and FIG. 1(b) is a side view of the strong diffracted light a generated in the edge portion d of the wafer 1 which is viewed from side, and Fig. (c) is an illustration showing the condition of the scattering light Se generated from the particle e existing on the surface of the wafer 1.

As shown in FIG. 1(a), a laser beam c for forming the laser beam Lt is irradiated onto the surface of the wafer 1 with a radius r, though when the laser beam c is irradiated to the edge portion d which is an outer peripheral end portion of the radius r of the wafer 1, as shown in FIG. 1(b), the strong diffracted light a is generated in the diameter direction of the wafer 1, and the weak (small) diffracted light b is generated in the tangential direction of the wafer 1.

The strong diffracted light a, since the irradiation position of the laser beam c which is the laser beam Lt irradiated onto the surface of the wafer 1 is controlled fixed and by scanning by irradiation of the laser beam Lt, the wafer 1 moves linearly in a predetermined fixed direction by rotating in the circumferential direction indicated by the arrow, exists always in the diameter direction of the wafer 1.

Therefore, the strong diffracted light a is formed always in the same direction to the light receptors which will be described later. By the influence of the diffracted light a, the scattering light Se generated from the particles e or defects (COP, scratches, cracks, etc.) existing on the surface of the wafer 1 is buried in noise due to the diffracted light a, so that it is difficult to obtain a desired detection signal of the scattering light Se.

As shown in FIG. 1(b), when the laser beam Lt of the laser beam c is irradiated to the wafer 1 which is the object to be inspected, when viewing the diffracted light a generated in the edge portion d of the wafer 1 from side, the laser beam c generates strong diffracted light a in the outer peripheral end portion of the wafer 1 in the radial direction, which is the edge portion d of the wafer 1.

Further, as shown in FIG. 1(c), the laser beam Lt of the laser beam c is irradiated onto the surface of the wafer 1 as a laser spot Sp and when particles e and defects such as COP exist on the surface of the wafer 1, scattering light Se is generated from the particles e and defects such as COP at a wide angle (direction).

When the position of the laser spot Sp of the laser beam Lt irradiated onto the surface of the wafer 1 is the edge portion d which is the end portion of the wafer 1 on the outside diameter side in the radial direction, if particles e and defects such as COP exist in the edge area d of the surface of the wafer 1, as mentioned previously, in the noise generated by the influence of the strong diffracted light a generated in the edge portion d of the wafer 1, the detection signal which detected the scattering light Se generated from the particles e and defects such as COP is buried, thus a desired detection signal of the scattering light Se cannot be obtained.

Therefore, in the inspection device of an object to be inspected which is an embodiment of the present invention, by the constitution indicated below, the influence of the noise by the diffracted light a generated in the edge portion d of the wafer 1 is removed or reduced, thus the scattering light Se generated from the particles e and defects such as COP on the surface of the wafer 1 can be detected effectively.

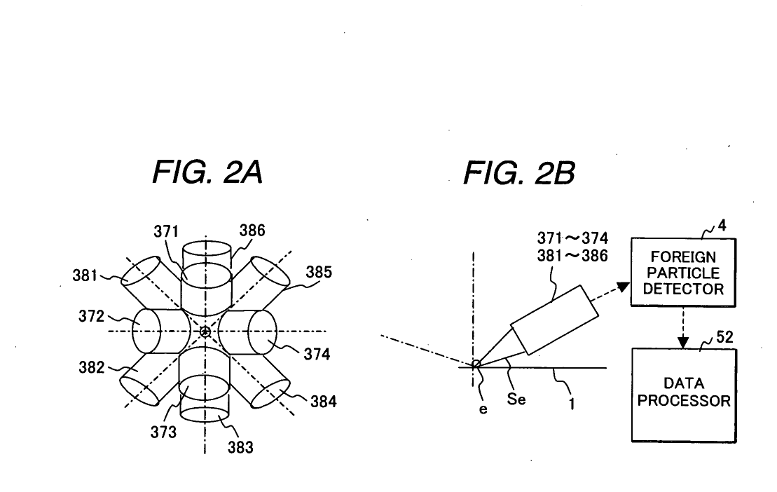

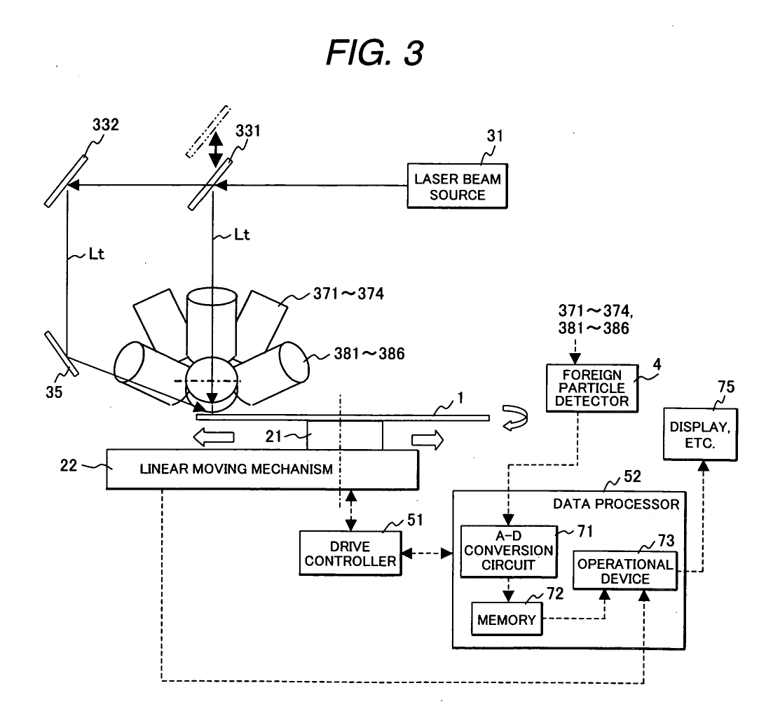

FIG. 3 is a schematic block diagram of the detection optical system composing the inspection device of an object to be inspected which is an embodiment of the present invention, and FIG. 2 is a schematic view of the light receptors composing the inspection device of the embodiment of the present invention shown in FIG. 3, and FIG. 2(a) is a top view showing the arrangement condition of the light receptors, and FIG. 2(b) is a schematic view showing the processing contents of the received signal when scattering light generated on the wafer surface is detected by the light receptor.

By referring to FIGS. 2 and 3, the constitution of the wafer inspection device for inspecting the surface of the wafer 1 as the object which is an embodiment of the present invention will be explained. FIG. 2(a) shows an example of the arrangement of light receptors 371 to 374 for a high angle composed of photo multiplier tubes (PMT) for detecting scattering light which become light receptors composing the inspection device of the wafer 1 and light receptors 381 to 386 for a low angle for detecting similarly scattering light which are viewed from above.

The light receptors 371 to 374 for a high angle are light receptors arranged at an angle of about 50 to 700 from the surface of the wafer 1 where the laser beam Lt irradiated onto the surface of the wafer 1 enters as scattering light Se scattered from particles and defects such as COP existing on the surface of the wafer 1.

Similarly, the light receptors 381 to 386 for a low angle are light receptors arranged at an angle of about 20 to 40° from the surface of the wafer 1 where the laser beam Lt irradiated onto the surface of the wafer 1 enters as scattering light Se scattered from particles and defects such as COP existing on the surface of the wafer 1.

FIG. 2(b) shows an example of the arrangement of the light receptors when the light receptors 371 to 374 for a high angle and the light receptors 381 to 386 for a low angle, which are shown in FIG. 2(a), are viewed from side and with respect to the light receptors 371 to 374 for a high angle, when viewed from above, so that the arrangement directions are different from each other by about 90° in the circumferential direction, four light receptors are arranged in the circumferential direction.

Further, with respect to the light receptors 381 to 386 for a low angle, when viewed from above, so that the arrangement directions are different from each other by about 60° in the circumferential direction, six light receptors are arranged in the circumferential direction.

And, among the light receptors 371 to 374 for a high angle and the light receptors 381 to 386 for a low angle, the light receptors influenced greatly by the strong diffracted light a in the diameter direction of the wafer 1 which is generated in the edge portion d of the wafer 1 by irradiation of the laser beam are the light receptors 372 and 374 for a high angle arranged in the diameter direction of the wafer 1 and the light receptors influenced strongly secondarily by the diffracted light a are the light receptors 382 and 385 for a low angle and the light receptors 381 and 384 for a low angle.

Further, the aforementioned light receptors influenced little by the strong diffracted light a are the light receptors 371 and 373 for a high angle arranged perpendicularly to the diameter direction of the wafer 1 and the light receptors influenced little secondarily by the diffracted light a are the light receptors 383 and 386 for a low angle.

Next, the constitution of inspection device of the wafer surface of this embodiment will be explained. As shown in FIG. 3, the inspection device includes a rotary table 21 for loading and rotating the wafer 1 to be inspected, a linear moving mechanism 22 for moving the rotary table 21 in the transfer direction of the wafer 1, a projector optical system, and a data processor 52 and the wafer 1 of an object to be inspected which is an inspection subject is loaded on the rotary table 21.

The projector optical system arranged above the wafer 1 has a laser beam source 31 having a laser generator, and the laser beam Lt which is outputted from the laser beam source 31 and irradiated to scan the surface of the wafer 1 is outputted from the laser beam source 31 and is reflected by a mirror 331 composing the first projector optical system, forms a laser spot Sp (hereinafter, referred to as a spot Sp) downward in the vertical direction, and is projected vertically onto the surface of the wafer 1 (vertical irradiation).

Further, in the second projector optical system composing the aforementioned projector optical system, from the optical path of the laser beam Lt outputted from the laser beam source 31, the mirror 331 composing the first projector optical system is moved to the upper position indicated by a two-dot chain line in the vertical direction so as to empty the optical path through which the laser beam Lt irradiated from the laser beam source 31 travels, and by a mirror 332 composing the second projector optical system arranged on the extension line of the optical path through which the laser beam Lt travels, the laser beam Lt is reflected downward in the vertical direction, and by another mirror 35 composing the second projector optical system, the reflected laser beam Lt is reflected toward the wafer 1 and is projected obliquely onto the surface of the wafer 1 as a laser spot Sp (oblique irradiation).

The laser spot Sp of the laser beam Lt irradiated vertically or the laser spot Sp of the laser beam Lt irradiated obliquely, according to the movement of the wafer 1 driven by the rotary table 21 and linear moving mechanism 22, scans the surface of the wafer 1.

The wafer 1 is structured so as to rotate by drive of the rotary table 21 and linear moving mechanism 22 in the state that it is loaded on the rotary table 21 and move in the radial direction (X direction: direction of void arrow in the drawing) of the rotary table 21 by drive of the linear moving mechanism 22 according to the rotational speed of the rotary table 21.

The inspection device of the wafer surface of this embodiment, as mentioned above, is composed of the first projector optical system and second projector optical system, so that the laser spot Sp irradiated onto the surface of the wafer 1 scans spirally on the surface of the wafer 1 from the center of the wafer 1 to the outer peripheral side thereof in the radial direction, thereby can scan overall the surface of the wafer 1.

Further, the drive of the rotary table 21 and linear moving mechanism 22 is controlled by the data processor 52 via a drive controller 51.

In the wafer surface inspection device of this embodiment, as shown in FIG. 1(c), when there are particles e and defects on the surface of the wafer 1, the laser spot Sp of the laser beam Lt generates scattering light Se at a wide angle (direction) due to the particles and defects.

With respect of the scattering light Se scattered at a wide angle (direction) due to the particles and defects existing on the surface of the wafer 1, as shown in FIG. 2(b), a part thereof is collected and is received by the light receptors 371 to 374 for a high angle and the light receptors 381 to 386 for a low angle composed of a photo multiplier tube (hereinafter, referred to as a PMT) which is a photoelectric converter, or the like.

The scattering light Se scattered from the particles or defects such as COP existing on the surface of the wafer 1 which enters the light receptors 371 to 374 for a high angle and the light receptors 381 to 386 for a low angle enters the light receptors 371 to 374 and light receptors 381 to 386 and is converted to a received signal by them, and the converted received signals (electric signals) are inputted to a foreign particle detector 4.

And, the received signals inputted to the foreign particle detector 4 are sent from the foreign particle detector 4 to the data processor 52, at the data processor 52, are converted to digital data by an A-D conversion circuit (A-D) 71 installed in the data processor 52, and then are stored once as digital data in a memory 72 installed in the data processor 52.

Furthermore, by an operational device (MPU) 73 installed in the data processor 52, a predetermined program is executed, thus the detection data of each received signal recorded once in the memory 72 and converted to the aforementioned digital data which is received by the light receptors 371 to 374 for a high angle and the light receptors 381 to 386 for a low angle is operated by the operational device (MPU) 73 of the data processor 52 together with the position data of the scanning position (detection position) of the laser spot Sp of the laser beam Lt for scanning the surface of the wafer 1 which is inputted from the movement distance of the linear moving mechanism 22, that is, is data-processed.

With the result that the data process is performed by the operational device (MPU) 73 of the data processor 52, the size of particles e and defects such as COP existing on the surface of the wafer 1 according to the detection data of the aforementioned received signals is decided and furthermore, the numbers of the particles e and defects such as COP are counted.

Furthermore, the operational device (MPU) 73 of the data processor 52 executes the predetermined program, thus the number and size of the particles e and defects such as COP existing on the surface of the wafer 1 and foreign particle data indicating the positions of the particles e and defects are generated and outputted to a printer or a display 75, and the condition of the particles and defects is mapped.

FIGS. 2(a) and 3 show the condition that the light receptors 371 to 374 for a high angle and the light receptors 381 to 386 for a low angle composed of a photo multiplier tube (PMT) are arranged respectively above the surface of the wafer 1, though the six light receptors 381 to 386 composing the group of the light receptors 381 to 386 for a low angle are arranged respectively at an angle of about 60° in the circumferential direction.

Further, the four light receptors 371 to 374 composing the group of the light receptors 371 to 374 for a high angle arranged above the light receptors 381 to 386 for a low angle are arranged respectively at an angle of about 90° in the circumferential direction.

And, among the light receptors 371 to 374 for a high angle, the light receptors 372 and 374 are arranged at the positions on the same line as or the parallel line to the diameter direction of the wafer 1 which is the object to be inspected (when the laser beam Lt is irradiated, the direction where strong diffracted light a is generated in a predetermined area corresponding to the edge portion d of the wafer 1) when the surface of the wafer 1 is viewed from above.

Further, the light receptors 371 and 373 are arranged at the positions on the same line as or the parallel line to the tangential direction of the wafer 1 which is the object to be inspected (the direction where strong diffracted light a is not generated in the predetermined area) when the surface of the wafer 1 is viewed from above, that is, in the direction perpendicular to the arrangement direction of the light receptors 372 and 374.

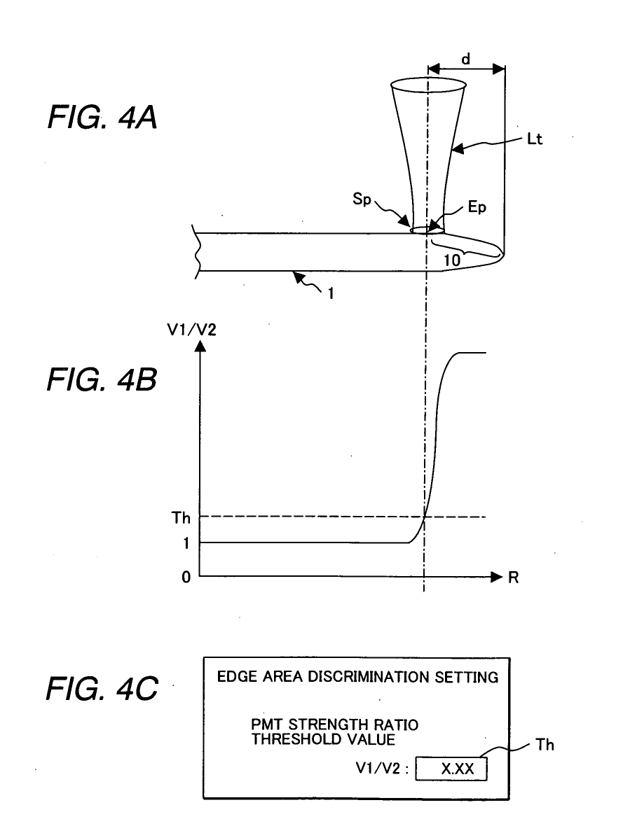

Next, by referring to FIG. 4, the inspection condition for the predetermined area corresponding to the edge portion d of the wafer 1 by the inspection device of this embodiment of the present invention will be explained.

FIG. 4(a) is a schematic view of the area neighboring with the edge portion d of the wafer 1 to which the laser beam Lt is irradiated, and FIG. 4(b) is a drawing showing the strength ratio of the noise components of the received signals detected by the light receptors 371 to 374 for a high angle and the light receptors 381 to 386 for a low angle, and FIG. 4(c) is a setting screen example of a threshold value on the screen of the device.

Firstly, the definition of the predetermined area corresponding to the edge portion d of the surface of the wafer 1 will be explained by referring to FIG. 4(a). As the peripheral part of the laser spot Sp of the laser beam Lt irradiated onto the surface of the wafer 1 comes from the plane area forming the greater part of the surface of the wafer 1 near to a portion Ep where the inclination thereof is started toward the outside end of the wafer 1 in the radial direction, the strength of the diffracted light a in the diameter direction of the wafer 1 which is generated by irradiation of the laser beam Lt is increased suddenly, thus the detection of scattering light Se generated from particles e and defects existing in the portion Ep of the surface of the wafer 1 is started to be influenced greatly.

Here, as described above, from the portion Ep at which the inclination where the diffracted light a of the surface of the wafer 1 is strengthened starts to the outer end portion of the wafer 1 in the radial direction is defined as a predetermined area 10 corresponding to the edge portion d of the wafer 1 or a bevel.

In this case, the portion Ep, which is a boundary between the plane area forming the greater part of the surface of the wafer 1 and the predetermined area 10, where the inclination starts becomes the boundary position Ep between the plane area and the predetermined area 10.

And, as shown in FIG. 1(a), the weak diffracted light b in the tangential direction of the wafer 1 which is generated when the laser beam Lt is irradiated to the predetermined area 10 corresponding to the edge portion d of the surface of the wafer 1 or the bevel, compared with the strong diffracted light a generated in the diameter direction of the wafer 1, does not influence greatly the detection of scattering light Se generated from particles e and defects.

When the scanning on the surface of the wafer 1 by the laser spot Sp of the laser beam Lt irradiated onto the surface of the wafer 1 reaches the predetermined area 10 beyond the boundary position Ep from the plane area forming the greater part of the surface of the wafer 1 which is the object to be inspected, between the light receptors (371, 373) for a high angle and the light receptors (383, 386) for a low angle arranged at an angle where no diffracted light is received (or little influenced by diffracted light) and the light receptors (372, 374) for a high angle and the light receptors (381, 382, 384, 385) for a low angle arranged at an angle where diffracted light is received (or greatly influenced by diffracted light), there are great differences in the noise level by the diffracted light mixed in the received signal for detecting scattering light Se generated from particles and defects such as COP existing on the surface of the wafer 1.

FIG. 4(b), when scattering light Se generated from particles e and defects such as COP is received respectively by the light receptors (371, 373, 383, 386) arranged at an angle where no diffracted light is received (or little influenced by diffracted light) and the light receptors (372, 374, 381, 382, 384, 385) arranged at an angle where the diffracted light is received (or greatly influenced by the diffracted light), shows a ratio of output voltages (V1/V2) calculated from an output voltage V1 which is outputted from the light receptors (372, 374, 381, 382, 384, 385) arranged at the angle where the diffracted light is received (or greatly influenced by the diffracted light) by the foreign particle detector 4 shown in FIGS. 2(b) and 3 and an output voltage V2 which is outputted from the light receptors (371, 373, 383, 386) arranged at the angle where no diffracted light is received (or little influenced by the diffracted light) together with the threshold value Th.

Here, the output voltage outputted from the light receptor (371, 373, 383, 386) arranged at the angle where no diffracted light is received (or little influenced by diffracted light) is V2 and the output voltage outputted from the light receptor (372, 374, 381, 382, 384, 385) arranged at the angle where diffracted light is received (or greatly influenced by diffracted light) is V1.

FIG. 4(b) indicates the ratio (V1/V2) of the output voltage V1 and output voltage V2 which are detected by the light receptors aforementioned on the axis of ordinates and the distance R from the center of the surface of the wafer 1 with a radius R to the outside end thereof in the radial direction on the axis of abscissas and shows the strength ratio of the noise components of the received signals of the scattering light which is calculated by the foreign particle detector 4 as a ratio V1/V2 of the output voltages together with the threshold value Th.

The output voltage ratio V1/V2 shown in FIG. 4(b), when the position of the surface of the wafer 1 to which the laser spot Sp of the scanning laser beam Lt is irradiated reaches the predetermined area 10 corresponding to the edge portion d of the outer end of the wafer 1 in the radial direction from the plane area, since the strong diffracted light a as shown in FIG. 1(a) is generated, is increased suddenly under the influence of the strong diffracted light a (or greatly influenced by the diffracted light), so that when the output voltage ratio V1/V2 is compared with the threshold value, the boundary position Ep between the plane area of the wafer 1 and the predetermined area 10 corresponding to the edge portion d of the outer end of the wafer 1 in the radial direction can be decided precisely.

Therefore, assuming the inspection condition for the wafer 1 for irradiating and scanning the laser spot Sp of the laser beam Lt onto the surface of the wafer 1, as just illustrated in FIG. 4(c), as optional setting of the threshold value Th to be compared with the output voltage ratio V1/V2, the operational device 73 of the data processor 52 performs comparison operations, thus the output voltage ratio V1/V2 detected by the light receptor shown in FIG. 4(b) is increased suddenly, and the position where it exceeds the threshold value Th is decided as a boundary position Ep between the plane area and the predetermined area 10, and overall the area exceeding the threshold value Th can be decided as a predetermined area 10 corresponding to the edge portion d of the surface of the wafer 1.

As mentioned above, the operational device 73 of the data processor 52 performs comparison operations on the basis of the received signal received by the aforementioned detector, thus the boundary position Ep between the plane area of the surface of the wafer 1 and the predetermined area 10 can be decided precisely.

As a result, with respect to the range for scanning the surface of the wafer 1, the effective range as a plane area of the wafer 1 which is irradiated and scanned by the laser spot Sp of the laser beam Lt can be set to a wide range extended precisely to its limit.

Further, as mentioned above, the operational device 73 of the data processor 52 performs comparison operations on the basis of the received signal received by the aforementioned detector, thus the range of the predetermined area 10 of the surface of the wafer 1 can be set precisely and when irradiating the laser spot Sp of the laser beam Lt to the predetermined area 10 and scanning it, the light receptor arranged at the position free of the influence of the diffracted light or influenced little is selected and the received signal can be selected.

As a result, the condition of particles e and defects such as COP existing in the predetermined area 10 can be measured without being influenced by the diffracted light or under little influence thereof.

Namely, when irradiating the leaser spot Sp of the laser beam Lt to the predetermined area 10 corresponding to the edge portion d of the wafer 1 and measuring existence of particles e and defects such as COP existing in the predetermined area 10, by the selection process by the operational device 73 of the data processor 52 disposed in the wafer surface inspection device of this embodiment, among the light receptors 371 to 374 for a high angle and the light receptors 381 to 386 for a low angle, the light receptors 371 and 373 for a high angle and the light receptors 383 and 386 for a low angle arranged at an angle where the strong diffracted light a generated in the edge portion d of the surface of the wafer 1 is not received (or little influenced by diffracted light) are selected, and on the basis of the received signal detected by each light receptor selected, the scattering light e generated from the particles e and defects such as COP existing in the predetermined area 10 of the wafer 1 is measured, thus without being influenced (or little influenced) by noise by the strong diffracted light a generated in the edge portion d of the surface of the wafer 1, the condition of the particles e and defects such as COP existing in the predetermined area 10 of the wafer 1 can measured precisely.

Or, by the selection process and sensitivity correction process by the operational device 73 of the data processor 52, among the light receptors 371 to 374 for a high angle and the light receptors 381 to 386 for a low angle, the light receptors 372 and 374 for a high angle (or the light receptors 381 and 384 and light receptors 382 and 385 for a low angle) arranged at an angle where the strong diffracted light a generated in the edge portion d is received (or greatly influenced by diffracted light) are selected, and the sensitivity correction process for lowering the light reception sensitivity of the selected light receptors is performed or the strength of the laser beam Lt irradiated to the surface of the wafer 1 is lowered for irradiation.

And, furthermore, on the basis of the received signal detected by the light receptor performing the correction process for lowering the selected sensitivity or the received signal when scattering light by the laser beam Lt irradiated with its strength lowered is detected by the light receptor, the scattering light e generated from the particles e and defects such as COP existing in the predetermined area 10 of the wafer 1 is measured, thus without being influenced (or little influenced) by noise by the strong diffracted light a generated in the edge portion d of the surface of the wafer 1, the condition of the particles e and defects such as COP existing in the predetermined area 10 of the wafer 1 can measured precisely.

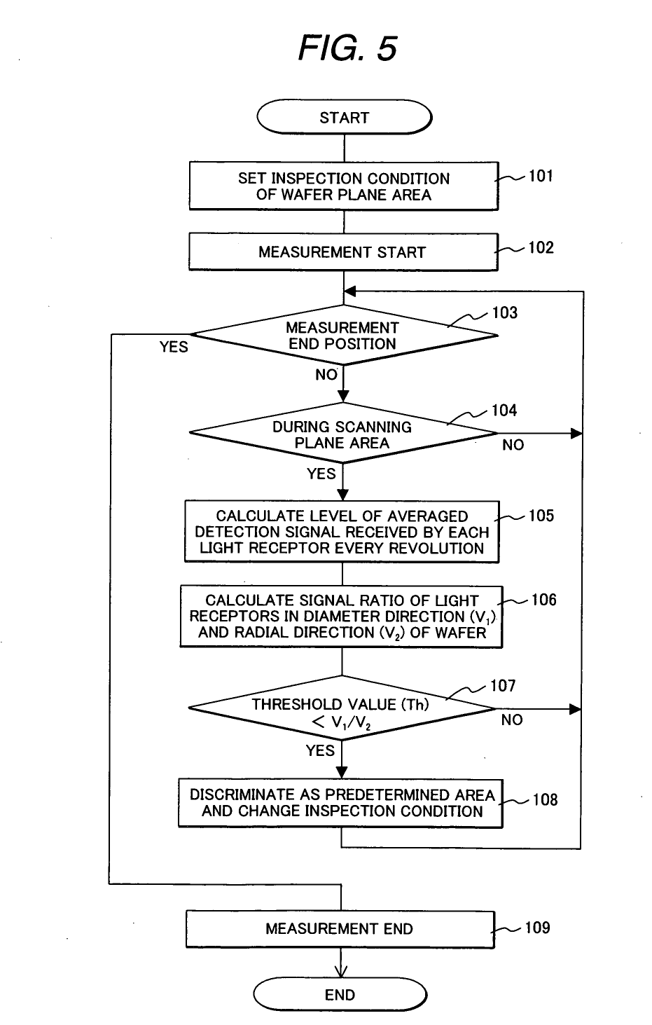

Next, by referring to the flow chart shown in FIG. 5, the flow of measurement of irradiating the laser spot Sp of the laser beam Lt and scanning the surface of the wafer 1 for existence of particles e and defects such as COP existing on the surface of the wafer 1 by the wafer surface inspection device of this embodiment shown in FIG. 3 will be explained.

Firstly, at Step 101 of setting the inspection condition of the wafer plane area, by the data processor 52 of the wafer surface inspection device which is this embodiment shown in FIG. 3, the inspection condition of the wafer plane area of the wafer 1 which is the object to be inspected is set.

Next, at Step 102 of measurement start, the rotation of the rotary table 21 of the wafer surface inspection device of this embodiment is started by an instruction from the drive controller 51 and by rotating the wafer 1 loaded on the rotary table 21 and moving the position of the laser spot Sp of the laser beam Lt irradiated onto the surface of the wafer 1 from the central part of the wafer 1 in the radial direction toward the outer end portion thereof in the radial direction, the measurement (scanning) is started.

At Step 104 during scanning the plane area, the plane area of the surface of the wafer 1 is irradiated with the laser spot Sp of the laser beam Lt by moving it from the central part of the wafer 1 in the radial direction toward the outer end portion thereof in the radial direction, thus the surface of the wafer 1 is scanned.

At the next Step 105 of calculating the level obtained by averaging every revolution of the detection signals received by the respective light receptors, while the laser spot Sp makes a round on the surface of the wafer 1, the level obtained by averaging the detection signals of the scattering light Se detected by the light receptors is calculated.

The laser spot Sp of the laser beam Lt is irradiated continuously and almost concentrically onto the surface of the wafer 1, and the scattering light Se scattered from the particles e or scratches existing on the surface of the wafer 1 is received by the light receptors 371 to 374 for a high angle and the light receptors 381 to 386 for a low angle, and the detection signals which are received signals, as mentioned above, are averaged every revolution by the data processor 52, thus the average level of the detection signals is calculated.

Next, the process goes to Step 106 where the output voltage ratio (V1/V2) of the output voltage V1 outputted from the light receptor which is arranged in the diameter direction of the wafer 1 and arranged at the angle where diffracted light is received (or greatly influenced by diffracted light) and the output voltage V2 outputted from the light receptor which is arranged in the radial direction of the wafer 1 and arranged at the angle where no diffracted light is received (or little influenced by diffracted light) is calculated and the signal ratio (V1/V2) of the light receptors disposed in the diameter direction (V1) of the wafer and the radial direction (V2) thereof is calculated.

And, by the data processor 52, the ratio (V1/V2) of the output voltages of the received signal detected by the light receptor arranged in the diameter direction of the wafer 1 and the received signal detected by the light receptor arranged in the radial direction thereof is calculated.

The position on the surface of the wafer 1 where the laser spot Sp of the laser beam Lt is irradiated moves from the center of the surface of the wafer 1 toward the outer end portion thereof in the radial direction, though the movement of the position of the laser spot Sp follows the movement of the position of the wafer 1 due to driving the linear moving mechanism 22.

Therefore, by comparing the input value of the movement distance of the linear moving mechanism 22 shown in FIG. 3 with the set value of the distance between the center of the wafer 1 and the predetermined area 10 of the surface of the wafer 1, the laser spot Sp of the laser beam Lt is irradiated by being moved so as to scan the surface of the wafer 1, and when the irradiation position approaches the predetermined area 10 from the plane area, the feed speed for moving the laser spot Sp of the laser beam Lt is set finely, thus the surface of the wafer 1 can be scanned concentrically.

And, the operational device (MPU) 73 of the data processor 52 operates the detection signal of the scattering light Se scattered from the particles e or defects such as COP existing on the surface of the wafer 1 which is received by the light receptor together with the position data of the scanning position (detection position) of the laser spot Sp of the laser beam Lt for scanning the surface of the wafer 1 and processes the data.

And, next, the process goes to Step 107 of judging threshold value (Th)<V1/V2, compares the calculated value of the output voltage ratio V1/V2 calculated by the operational device 73 of the data processor 52 with the preset threshold value Th shown in FIG. 4(b) and judges that the position on the surface of the wafer 1 where the laser spot Sp of the laser beam Lt is irradiated at present where the calculated value of the output voltage ratio V1/V2 exceeds the threshold value Th is the boundary position Ep between the plane area of the surface of the wafer 1 and the predetermined area 10 corresponding to the edge portion d of the wafer 1.

To measure precisely the boundary position Ep between the plane area of the surface of the wafer 1 and the predetermined area 10, when the laser spot Sp of the laser beam Lt for scanning the surface of the wafer 1 approaches the neighborhood of the predetermined area 10, the transfer of the laser spot Sp of the laser beam Lt is made fine and the laser spot Sp of the laser beam Lt is permitted to irradiate the surface of the wafer 1 almost concentrically.

When the laser spot Sp of the laser beam Lt is irradiated like this, even if particles e or defects exist in the irradiation position of the surface of the wafer 1 which is scanned almost concentrically, from the detection signal when the light receptor detects the scattering light e generated from the particles e or defects, from a plurality of neighboring positions on the circumference when the surface of the wafer 1 is scanned almost concentrically, the detection signal by the scattering light e generated from the particles e or defects is detected, so that if the detection signal by the scattering light e generated from the particles e or defects is deleted by calculation by the operational device 73 of the data processor 52, the boundary position Ep between the plane area of the surface of the wafer 1 and the predetermined area 10 corresponding the edge portion d of the wafer 1 can be decided precisely.

Further, the feed amount of the laser spot Sp of the laser beam Lt irradiated onto the surface of the wafer 1 when it approaches the neighborhood of the predetermined area 10 may be set finely such as ¼ to ½ of the ordinary feed amount.

Next, the process judges that overall the area where the calculated value of the output voltage ratio V1/V2 exceeds the threshold value Th is the predetermined area 10 of the surface of the wafer 1 corresponding to the edge portion d of the wafer 1.

And, thereafter, the process goes to Step 108, in correspondence with the inspection of irradiating the laser beam Lt to the predetermined area 10 of the surface of the wafer 1 and scanning, of discriminating it as a predetermined area and changing the inspection condition and when the operational device 73 of the data processor 52 judges that the position irradiated and scanned with the laser spot Sp of the laser beam Lt passes the boundary position Ep from the plane area and moves to the predetermined area, the operational device 73 of the data processor 52 changes and sets the inspection condition for the predetermined area when the predetermined area 10 of the wafer 1 is irradiated and scanned with the laser spot Sp of the laser beam Lt.

Namely, the process adjusts so as to lower the strength of the laser beam Lt irradiated from the laser beam source 31 for irradiating the laser spot Sp of the laser beam Lt for scanning the predetermined area 10 of the surface of the wafer 1 or adjusts the light reception sensitivity of the light receptor for receiving the scattering light Se and sets so as to lower the light reception sensitivity of the light receptor arranged at the position where the scattering light Se generated from particles e or defects existing in the predetermined area 10 of the surface of the wafer 1 is received.

As mentioned above, when the inspection condition in the predetermined area 10 is changed and set, it is possible to reduce the influence of the strong diffracted light generated in the edge portion d of the surface of the wafer 1 and detect the scattering light e generated from the particles e or defects existing in the predetermined area 10 of the surface of the wafer 1, thus the particles e or defects existing in the predetermined area 10 can be detected.

And, when the inspection at Step 108 of discriminating the predetermined area and changing the inspection condition is finished and when at Step 107 of judging threshold value (Th)<V1/V2, the calculated value of the output voltage ratio V1/V2 is just lower than the threshold value Th, the process goes to Step 103 of the measurement end position and when the scanning is completed until the position of the laser spot Sp of the laser beam Lt reaches the measurement end position of the surface of the wafer 1, the process goes to Step 109 of the measurement end and the measurement of the surface of the wafer 1 is finished.

In the aforementioned wafer surface inspection device of this embodiment, the wafer 1 loaded on the rotary table 21 is rotated, and the laser spot Sp of the laser beam Lt is irradiated onto the surface of the wafer 1, and the scattering light Se generated from the particles e or defects existing on the surface of the wafer 1 is received by the light receptors, thus the condition of the particles e or defects is inspected, though the deterioration of the light receptors and the reduction in the detection precision of the scattering light e are suppressed by the countermeasures indicated below.

Namely, in the wafer surface inspection device of this embodiment, to suppress the reduction in the detection sensitivity of the scattering light e in the inspection of the predetermined area 10 of the surface of the wafer 1 corresponding to the edge portion d of the wafer 1, from a plurality of light receptors disposed for detecting the scattering light Se generated from the particles e or defects existing on the surface of the wafer 1, the light receptors in the arrangement direction where the strong diffracted light generated in the edge portion d of the wafer 1 does not enter as far as possible are selected, and using the received signals in which the scattering light is detected by the selected light receptors, the particles e and defects such as scratches and crystalline defects (COP) are detected highly precisely.

Further, the strong diffracted light a generated in the edge portion d of the wafer 1 is generated in the diameter direction of the wafer which is kept always constant for the rotation of the wafer 1, so that the light receptors arranged at the position outside the angle for receiving the diffracted light a for detecting the scattering light Se generated from the particles e or defects existing on the surface of the wafer 1 are selected, and on the basis of the received signals of the scattering light e by the selected light receptors, the particles e and defects existing on the surface of the wafer 1 are detected highly precisely.

Namely, in the wafer surface inspection device of this embodiment, as light receptors for detecting the scattering light generated from the particles e or defects existing on the surface of the wafer 1 free of the influence of the strong diffracted light a generated in the edge portion d of the wafer 1 shown in FIG. 1(a), from many light receptors arranged, the light receptors 371 and 373 for a high angle and the light receptors 383 and 386 for a low angle are selected, and these selected light receptors detect effectively the scattering light Se generated from the particles e or defects existing on the surface of the wafer 1, thus the condition of the particles e or defects is measured (inspected) highly precisely.

Further, the number and arrangement position of the light receptors may be set properly at the position free of the strong diffracted light a.

According to this embodiment of the present invention, when inspecting the surface of the object to be inspected by irradiating the laser beam, to enable to set the range of the plane area which is an inspection subject of the object as wide as possible, an inspection device and an inspection method of the object to be inspected for discriminating precisely and inspecting the boundary position between the plane area and the predetermined area corresponding to the edge portion of the object neighboring with the plane area can be realized.

### Embodiment 2

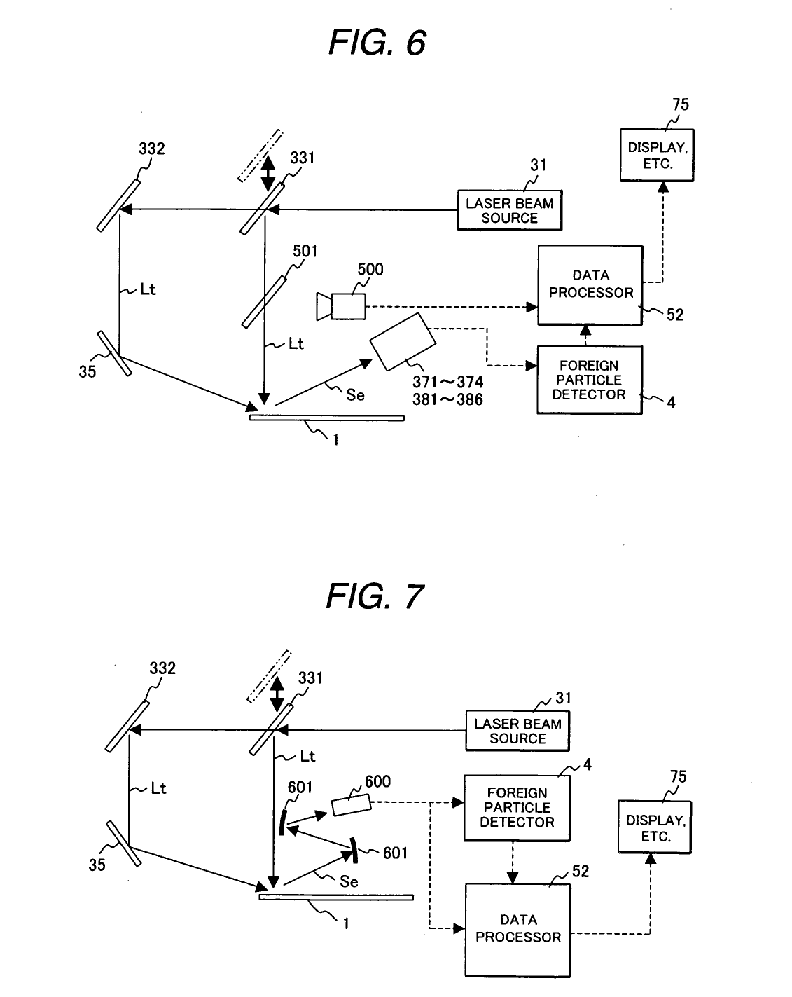

Next, the inspection device and inspection method of the object which is another embodiment of the present invention will be explained below by referring to FIG. 6.

The inspection device of the object to be inspected in this embodiment shown in FIG. 6 shares mostly the constitution and operation of the inspection device of the object to be inspected in the preceding embodiment shown in FIGS. 1 to 5, so that for the constitution common to the two, the explanation will be omitted and only the different constitution will be explained.

In FIG. 6, in the inspection device of the object to be inspected in this embodiment, with respect to the discrimination of the boundary position Ep between the predetermined area 10 corresponding to the edge portion d of the surface of the wafer 1 and the flat plane area, a half-mirror 510 for reflecting the shape of the laser spot Sp of the laser beam Lt irradiated onto the surface of the wafer 1 and periphery of the shape of laser spot Sp and an observation camera 500 for imaging the shape of the laser spot Sp and the periphery of the shape of the laser spot Sp which are reflected by the half-mirror 501 are disposed, and from the image data of the shape of the laser spot Sp and the image data of the periphery of the shape of the laser spot Sp which are picked up by the observation camera 500, the discrimination of the boundary position Ep and the discrimination of the range of the predetermined area 10 are performed by the image recognition art of the data processor 52.

Namely, the half-mirror 501 is arranged in the optical path through which the laser beam Lt is irradiated in the vertical direction toward the surface of the object to be inspected from above the surface of the wafer 1 which is the object and for the image of the shape of the laser spot Sp when the laser spot Sp of the laser beam Lt transmitting the half-mirror 501 is irradiated onto the surface of the wafer 1 and the image of the periphery of the shape of the laser spot, Sp, the observation camera 500 for picking up an image of the shape of the laser spot Sp reflected via the half-mirror 501 and the image of the periphery of the shape of the laser spot Sp is disposed.

Namely, to avoid interference of the laser beam Lt outputted from the laser beam source 31 of the projector optical system which is reflected by the mirror 331 and is projected downward in the vertical direction toward the surface of the wafer 1 to the image for reflecting the position of the laser spot Sp of the laser beam Lt irradiated onto the surface of the wafer 1, the half-mirror 501 for transmitting the laser beam Lt and reflecting and picking up the image of the position of the laser spot Sp irradiated onto the surface of the wafer 1 and the periphery thereof in the arrangement direction of the observation camera 500 are disposed.

The observation camera 500 has the number of pixels and resolution for picking up an image of the shape of the laser spot Sp when the laser spot Sp of the laser beam Lt irradiated by the projector optical system is irradiated onto the surface of the wafer 1 and the peripheral part of the laser spot Sp.

In this embodiment, the image of the shape of the laser spot Sp irradiated onto the surface of the wafer 1 while the surface of the wafer 1 is irradiated and scanned with the later spot Sp of the laser beam Lt and the image of the peripheral part of the laser spot Sp is picked up by the observation camera 500 and is obtained successively as image data, and the image data is analyzed by the image recognition art of the data processor 52 installed in the inspection device of this embodiment and the boundary position Ep between the plane area of the surface of the wafer 1 and the predetermined area and the range of the predetermined area 10 corresponding to the edge portion of the wafer 1 are discriminated.

Namely, when the shape of the later spot Sp of the laser beam Lt imaged by the observation camera 500, for example, when the irradiated position of the laser spot Sp is in the plane area of the surface of the wafer 1, is a circle and the irradiation position of the laser spot Sp enters the boundary position Ep where the plane area is changed to the predetermined area 10 corresponding to the edge portion d of the wafer 1, the shape of the laser spot Sp is changed to an ellipse by the inclined surface of the edge portion d.

Therefore, when the image recognition art for pattern-matching the shape of the laser spot Sp imaged by the observation camera 500 by the data processor 52 is applied, the boundary position Ep between the plane area of the surface of the wafer 1 and the predetermined area 10 can be discriminated highly precisely.

Further, by a method similar to the aforementioned, the range of the predetermined area 10 corresponding to the edge portion d of the wafer 1 can be discriminated.

Further, the scattering light Se scattered from the particles e and defects such as scratches and crystalline defects (COP) existing on the surface of the wafer 1, similarly to the preceding embodiment, is detected by the light receptors 371 to 374 for a high angle and the light receptors 381 to 386 for a low angle, and the received signals detected by the light receptors are sent to the foreign particle detector 4 and data processor 52 and are calculated, and the size and position of the particles e and defects are displayed on a display 75.

Further, in this embodiment, the discrimination of the boundary position Ep and the discrimination of the condition of the particles e and defects existing on the surface of the wafer 1 are the same as those of the preceding embodiment explained by referring to FIGS. 1 to 5, so that the explanation thereof is omitted, though the boundary position Ep between the plane area of the surface of the wafer 1 and the predetermined area 10 is discriminated highly precisely, and the scattering light Se generated from the particles e and defects existing on the surface of the wafer 1 is detected effectively by the light receptors, thus the condition of the particles e and defects can be measured highly precisely.

According to this embodiment of the present invention, when inspecting the surface of the object to be inspected by irradiating the laser beam, to enable to set the range of the plane area which is an inspection subject of the object as wide as possible, an inspection device and an inspection method of the object to be inspected for discriminating precisely and inspecting the boundary position between the plane area and the predetermined area corresponding to the edge portion of the object neighboring with the plane area can be realized.

### Embodiment 3

Next, the inspection device and inspection method of the object to be inspected which are still another embodiment of the present invention will be explained below by referring to FIG. 7.

The inspection device of the object to be inspected in this embodiment shown in FIG. 7 also shares mostly the constitution and operation of the inspection device of the object to be inspected in the preceding embodiment shown in FIGS. 1 to 5, so that for the constitution common to the two, the explanation will be omitted and only the different constitution will be explained.

In FIG. 7, the inspection device of the object to be inspected in this embodiment is structured such that in the discrimination of the boundary position Ep between the flat plane area of the surface of the wafer 1 and the predetermined area corresponding to the edge portion d, the discrimination of the range of the predetermined area 10, and the discrimination of the condition of the particles e and defects existing on the surface of the wafer 1, the laser spot Sp of the laser beam Lt is irradiated onto the surface of the wafer 1 and scattering light Se scattered on the surface of the wafer 1 is received, so that a plurality of light collecting mirrors 601 disposed above the wafer 1 for reflecting the scattering light Se and a line sensor 600 composed of, for example, many sensors arranged in a circular ring shape in order to receive the scattering light Se reflected by the plurality of light collecting mirrors 601 are disposed, and depending on the position of the line sensor 600 for receiving the scattering light Se reflected by the light collection mirrors 601, the scattering light, on the basis of the received signals of the sensors receiving it, is sent to the foreign particle detector 4 and data processor 52 and is operated, and the size and position of the particles e and defects are displayed on the display 75.

And, as a result, the inspection device is structured such that the discrimination of the boundary position Ep between the flat plane area of the surface of the wafer 1 and the predetermined area 10 corresponding to the edge portion d, the discrimination of the range of the predetermined area 10, and the discrimination of the condition of the particles e and defects existing on the surface of the wafer 1 are executed and the position of the boundary position Ep and the size and position of the particles e and defects are displayed on the display 75.

In this embodiment, as an effect of use of the line sensor 600 for receiving the scattering light Se, compared with the light receptors of the preceding embodiment using the photo multiplier tube (PMT), even if strong diffracted light enters, a respect that the light receptors hardly break down may be cited.

Further, also in the line sensor 600 in this embodiment, similar to the case that the scattering light Se is received by the light receptors in the preceding embodiment, the received signal V1 of the scattering light Se scattered from the surface of the wafer 1 in the area which is influenced by strong diffracted light a generated in the diameter direction of the wafer 1 or is easily influenced by the diffracted light a and the received signal V2 of the scattering light Se scattered from the surface of the wafer 1 in the area which is influenced by weak diffracted light b generated in the tangential direction of the edge portion of the wafer 1 or is easily influenced by the diffracted light b are obtained respectively.

And, similarly to the operations in the preceding embodiment shown in FIGS. 1 to 5, the ratio (V1/V2) of the output voltage 1 of the received signals detected by the plurality of sensors of the line sensor 600 to the output voltage V2 of the received signals is compared with the threshold value Th set optionally, thus the position of the surface of the wafer 1 exceeding the threshold value Th can be judged precisely as the boundary position Ep between the flat surface area of the wafer 1 and the predetermined area corresponding to the edge portion d of the wafer 1.

Further, the line sensor 600 in this embodiment can receive the scattering light Se scattered from the particles e and defects existing on the surface of the wafer 1 without influenced much by the diffracted light aforementioned, so that the condition of these particles e and defects can be detected highly precisely.

Furthermore, when measuring the condition of particles e and defects existing in the predetermined area 10 corresponding to the edge portion, among the line sensor 600, the sensors positioned within the range of the angle not influenced by the strong diffracted light a as noise are selected, thus the reduction in the sensitivity can be minimized, and the condition of the particles e and defects existing in the predetermined area 10 can be inspected.

As mentioned above, the boundary position Ep between the surface area of the wafer 1 and the predetermined area is discriminated precisely, thus not only the flat plane area of the surface of the wafer 1 can be used at its maximum but also the condition of the particles e and defects in the predetermined area corresponding to the edge portion d of the wafer 1 which cannot be measured conventionally can be managed, and fatal defects of the wafer 1 are not overlooked.

Therefore, defective semiconductor ICs manufactured from a wafer 1 inspected with this embodiment applied to can be reduced greatly.

According to this embodiment of the present invention, when inspecting the surface of an object to be inspected by irradiating the laser beam, to enable to set the range of the plane area which is an inspection subject of the object as wide as possible, an inspection device and an inspection method of the object to be inspected for discriminating precisely and inspecting the boundary position between the plane area and the predetermined area corresponding to the edge portion of the object neighboring with the plane area can be realized.

The present invention can be applied to an inspection device and an inspection method of the condition of the surface of the object to be inspected such as a wafer and more particularly to an inspection device and an inspection method for inspecting the surface of the object to be inspected such as a wafer by irradiating a laser beam.

What is claimed is:

1. An inspection device of an object to be inspected, comprising:
a laser beam source for oscillating a laser beam and irradiating the laser-beam onto a surface of an object to be inspected, a rotary table for loading and rotating the object, a moving mechanism for moving the rotary table in a transfer direction of the object, a plurality of light receptors disposed above the object for receiving a scattering light scattered from the surface of the object when the laser beam irradiated from the laser beam source onto the surface of the object loaded on the rotary table, and a data processor for performing operations on the basis of received signals of the scattering light received by the plurality of light receptors and discriminating a boundary position between a flat plane area of the surface of the object which is irradiated with the laser beam and a predetermined area corresponding to an edge portion outside the plane area.

2. An inspection device of an object to be inspected, comprising: a laser beam source for oscillating a laser beam and irradiating the laser beam onto a surface of an object to be inspected, a rotary table for loading and rotating the object, a moving mechanism for moving the rotary table in a transfer direction of the object, a plurality of light receptors disposed above the object for receiving a scattering light scattered from the surface of the object when the laser beam irradiated from the laser beam source onto the surface of the object loaded on the rotary table, a half-mirror disposed half way an optical path of the laser beam irradiated onto the surface of the object in a vertical direction from above for transmitting the laser beam, a camera for picking up an image of a laser spot of the laser beam irradiated onto the surface of the object which is reflected in the half-mirror, and a data processor for performing operations on the basis of the image of the laser beam spot picked up by the camera and received signals of the scattering light received by the plurality of light receptors, wherein
the data processor performs operations on the basis of the image of the laser spot to discriminate a boundary position between a flat plane area of the surface of the object which is irradiated with the laser beam and a predetermined area corresponding to an edge portion outside the plane area.

3. An inspection device of an object to be inspected, comprising:
a laser beam source for oscillating a laser beam and irradiating the laser beam onto a surface of an object to be inspected, a rotary table for loading and rotating the object, a moving mechanism for moving the rotary table in a transfer direction of the object, a plurality of light collecting mirrors disposed above the object for collecting a scattering light scattered from the surface of the object when the laser beam irradiated from the laser beam source onto the surface of the object loaded on the rotary table, a line sensor having a plurality of sensors disposed above the object for receiving the scattering light collected by the light collection mirrors, and a data processor for performing operations on the basis of received signals of the scattering light received by the sensors on the line sensor, wherein
the data processor performs operations on the basis of the received signals of the scattering light detected by the plurality of sensors of the line sensor to discriminate a boundary position between a flat plane area of the surface of the object which is irradiated with the laser beam and a predetermined area corresponding to an edge portion outside the plane area.

4. The inspection device of an object to be inspected according to claim 1, wherein
the data processor, on the basis of the received signals of the scattering light received by the plurality of light receptor, selects a sensor arranged at a position influenced little by diffracted light generated in the edge portion of the object, and on the basis of a received signal of the scattering light detected by the selected sensor, measures a condition of particles and defects of the surface of the object.

5. The inspection device of an object to be inspected according to claim 2, wherein
the data processor, on the basis of the received signals of the scattering light received by the plurality of light receptor, selects a sensor arranged at a position influenced little by diffracted light generated in the edge portion of the object, and on the basis of a received signal of the scattering light detected by the selected sensor, measures a condition of particles and defects of the surface of the object.

6. The inspection device of an object to be inspected according to claim 3, wherein
the data processor, on the basis of the received signals of the scattering light received by the plurality of sensors disposed in the line sensor, selects a sensor arranged at a position influenced little by diffracted light generated in the edge portion of the object, and on the basis of a received signal of the scattering light detected by the selected sensor, measures a condition of particles and defects of the surface of the object.

7. The inspection device of an object to be inspected according to claim 1, wherein
a projector optical system for irradiating the laser beam oscillated from the laser beam source onto the surface of the object comprising:
a first projector optical system for irradiating the laser beam downward in the vertical direction from above the object, and
a second projector optical system for irradiating the laser beam downward in the oblique direction from above the object, wherein
the plurality of light receptors or the line sensor is arranged so as to receive scattering light when the laser beams irradiated from the first projector optical system and the second projector optical system are scattered on the surface of the object.

8. The inspection device of an object to be inspected according to claim 2, wherein
a projector optical system for irradiating the laser beam oscillated from the laser beam source onto the surface of the object comprising:
a first projector optical system for irradiating the laser beam downward in the vertical direction from above the object, and
a second projector optical system for irradiating the laser beam downward in the oblique direction from above the object, wherein
the plurality of light receptors or the line sensor is arranged so as to receive scattering light when the laser beams irradiated from the first projector optical system and the second projector optical system are scattered on the surface of the object.

9. The inspection device of an object to be inspected according to claim 3, wherein
a projector optical system for irradiating the laser beam oscillated from the laser beam source onto the surface of the object comprising
a first projector optical system for irradiating the laser beam downward in the vertical direction from above the object, and
a second projector optical system for irradiating the laser beam downward in the oblique direction from above the object, wherein
the plurality of light receptors or the line sensor is arranged so as to receive scattering light when the laser beams irradiated from the first projector optical system and the second projector optical system are scattered on the surface of the object.

10. The inspection device of an object to be inspected according to claim 1, wherein
the object is a semiconductor wafer or an insulating wafer.

11. An inspection method of an object to be inspected, comprising the steps of:
driving a rotary table and a moving mechanism to move the rotary table in a transfer direction of an object to be inspected and rotating the object loaded on the rotary table,
irradiating a laser beam from a laser beam source disposed above the object onto a surface of the object, receiving a scattering light scattered from the surface of the object by a plurality of light receptors disposed above the object when the laser beam irradiated from the laser beam source onto the surface of the object, and
performing operations by a data processor on the basis of received signals of the scattering light received by the plurality of light receptors and discriminating a boundary position between a flat plane area of the surface of the object which is irradiated with the laser beam and a predetermined area corresponding to an edge portion outside the plane area.

12. An inspection method of an object to be inspected, comprising the steps of:
driving a rotary table and a moving mechanism to move the rotary table in a transfer direction of an object to be inspected and rotating the object loaded on the rotary table,
irradiating a laser beam from a laser beam source disposed above the object onto a surface of the object,
receiving a scattering light scattered from the surface of the object by a plurality of light receptors disposed above the object when the laser beam irradiated from the laser beam source onto the surface of the object,
reflecting an image of a laser spot of the laser beam irradiated from the laser beam source onto the surface of the object by a half-mirror disposed above the object for transmitting the laser beam,
picking up an image of the laser spot of the laser beam irradiated onto the surface of the object which is reflected in the half-mirror by a camera, and
performing operations by a data processor on the basis of the image of the laser spot picked up by the camera and discriminating a boundary position between a flat plane area of the surface of the object which is irradiated with the laser beam and a predetermined area corresponding to an edge portion outside the plane area.

13. An inspection method of an object to be inspected, comprising the steps of:
driving a rotary table and a moving mechanism to move the rotary table in a transfer direction of an object to be inspected and rotating the object loaded on the rotary table,
irradiating a laser beam from a laser beam source disposed above the object onto a surface of the object,
collecting a scattering light scattered from the surface of the object by a plurality of light collecting mirrors disposed above the object when the laser beam irradiated from the laser beam source onto the surface of the object,
receiving the scattering light collected by the light collecting mirrors by a line sensor having a plurality of sensors, and
performing operations by a data processor on the basis of received signals of the scattering light received respectively by the plurality of sensors of the line sensor and discriminating a boundary position between a flat plane area of the surface of the object which is irradiated with the laser beam and a predetermined area corresponding to an edge portion outside the plane area.

14. The inspection method of an object to be inspected according to claim 11, the performing operation by the data processor further comprising the steps of:
selecting a sensor arranged at a position influenced little by diffracted light generated in the edge portion of the object on the basis of the received signals of scattering light received by the plurality of light receptor, and
measuring a condition of particles and defects of the surface of the object on the basis of a received signal of the scattering light detected by the selected sensor.

15. The inspection method of an object to be inspected according to claim 13, the performing operation by the data processor further comprising the steps of:
selecting a sensor arranged at a position influenced little by diffracted light generated in the edge portion of the object on the basis of the received signals of scattering light received by the plurality of sensors disposed in the line sensor, and
measuring a condition of particles and defects of the surface of the object on the basis of a received signal of the scattering light detected by the selected sensor.

16. The inspection method of an object to be inspected according to claim 12, the performing operation by the data processor further comprising the steps of:
selecting a sensor arranged at a position influenced little by diffracted light generated in the edge portion of the object on the basis of the received signals of scattering light received by the plurality of sensors disposed in the line sensor, and
measuring a condition of particles and defects of the surface of the object on the basis of a received signal of the scattering light detected by the selected sensor.

17. The inspection method of an object to be inspected according to claim 11, wherein the object is a semiconductor wafer or an insulating wafer.
